(19) United States
(12) Patent Application Publication
(10) Pub. No.: US 2022/0286778 A1
(43) Pub. Date: Sep. 8, 2022

(54) Surround Sound Neckband

(71) Applicant: Jeffery Colvin, Cincinnati, OH (US)

(72) Inventor: Jeffery Colvin, Cincinnati, OH (US)

(21) Appl. No.: 17/686,282

(22) Filed: Mar. 3, 2022

Related U.S. Application Data
(60) Provisional application No. 63/156,175, filed on Mar. 3, 2021.

(51) Int. Cl. H04R 5/02; H04R 3/00

(52) U.S. Cl. CPC H04R 5/02; H04R 3/00; H04R 2420/07; H02J 7/0063

(57) ABSTRACT

A surround sound neckband includes a housing, a plurality of speakers, an amplifier, a rechargeable battery, and a plurality of control buttons. The plurality of speakers is connected to the housing and provides a surround sound and bass sound to the user as the housing is worn around the neck area of the user. The amplifier is connected within the housing to amplify emitting sounds. The rechargeable battery is connected within the housing so that the plurality of speakers, the amplifier, and the plurality of control buttons can be electrically powered. The plurality of control buttons is connected onto the housing so that the user can control the emitting sounds.

The current application claims a priority to the U.S. Provisional Patent application Ser. No. 63/156,175 filed on Mar. 3, 2021.

### FIELD OF THE INVENTION

The present invention relates generally to a surround sound apparatus. More specifically, the present invention is a surround sound neckband that provides rumble feedback and surround sound to enhance user experience.

### BACKGROUND OF THE INVENTION

Surround sound is a technique for enriching the fidelity and depth of sound reproduction by using multiple audio channels from speakers that surround the listener. More specifically, surround sound adds one or more channels from speakers to the side or behind the listener that are able to create the sensation of sound coming from any horizontal direction around the listener. Even though, the surround sound technology has started with the movie theater industry, it has evolved into individual usage, gaming industry, audio professionals, virtual reality, residential sound systems, and many other similar fields. In particular, gaming consoles and experiences on personal computers keep improving with better graphics and new online gaming platforms. Virtual reality has introduced a new way to immerse the player into the gaming world that gives the player a new experience.

It is an objective of the present invention to provide a surround sound neckband that can further enhance the user experience via a rumble feedback. More specifically, the present invention can wirelessly connect with a gaming console, a gaming computer, or any other type of electronic device that emits audio files so that the user can experience the surround sounds. The present invention also provides rumbling feedback into the user's body so that the user can further experience the depth of the surround sound.

### BRIEF DESCRIPTION OF THE DRAWINGS

FIG. 1 is a top perspective view of the present invention.

FIG. 2 is a bottom perspective view of the present invention.

FIG. 3 is a top view of the present invention.

FIG. 4 is a rear view of the present invention.

FIG. 5 is a basic schematic showing the electrical connections of the present invention.

FIG. 6 is a basic schematic showing the electronical connections of the present invention.

### DETAIL DESCRIPTIONS OF THE INVENTION

All illustrations of the drawings are for the purpose of describing selected versions of the present invention and are not intended to limit the scope of the present invention.

The present invention is a surround sound neckband that wirelessly connects to any gaming consoles, gaming computers, or any other type of audio output. The present invention is designed to be worn around the user's neck area and positioned about the chest level so that the emitting sound can travel to user's ears. The present invention processes and plays the sound so that the sound rumbles through the user's body and emits towards the user's ears thus enhancing the user experience.

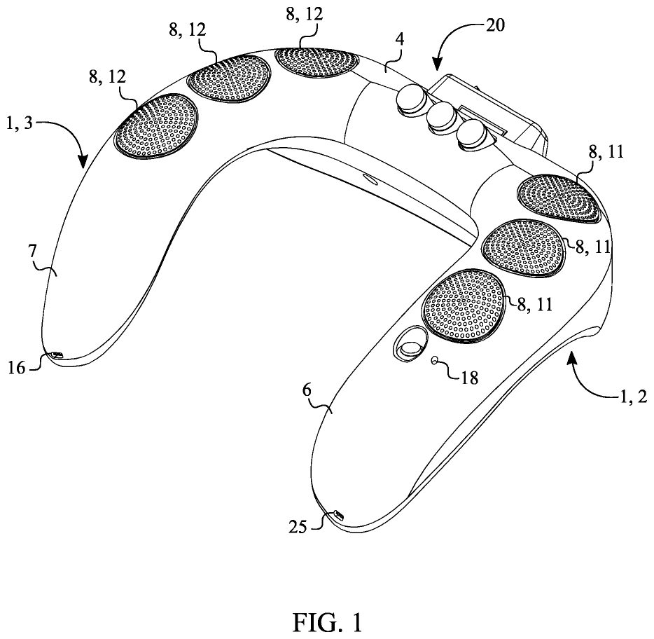

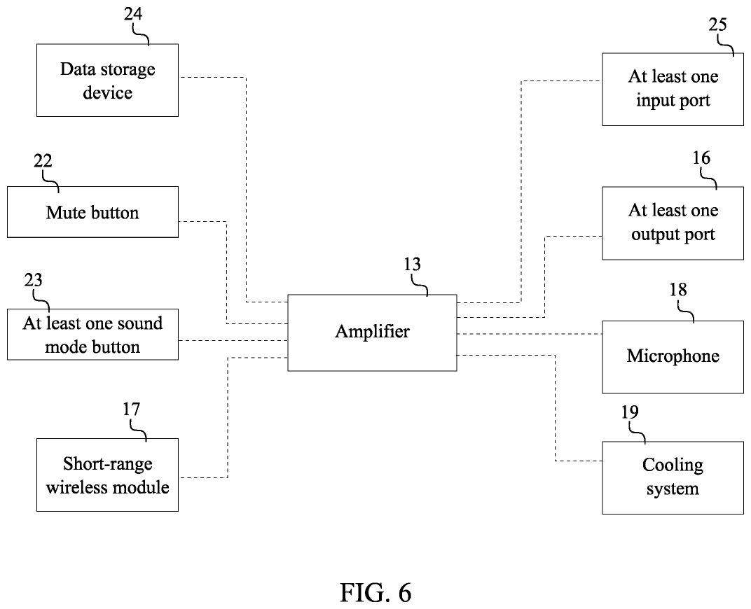

As shown in FIG. 1-6, the present invention comprises a housing 1, a plurality of speakers 8, an amplifier 13, a rechargeable battery 14, and a plurality of control buttons 20. The housing 1 functions as the structural body and enables the configurations of the rest of the components. The housing 1 comprises a contacting portion 2 and an exposed portion 3, wherein the contacting portion 2 and the exposed portion 3 are perimetrically mounted to each other. The plurality of speakers 8 is internally mounted to the housing 1 so that the sound can be emitted through the housing 1. The amplifier 13 is mounted within the contacting portion 2 and the exposed portion 3 so that the emitting sound can be amplified upon user preference. The plurality of control buttons 20 is connected onto the housing 1 so that the user can easily access the plurality of control buttons 20 to operate the present invention and control the emitting sound. The rechargeable battery 14 is mounted within the contacting portion 2 and the exposed portion 3 and functions as a power source. As a result, the plurality of speakers 8, the amplifier 13, and the plurality of control buttons 20 are electrically connected to the rechargeable battery 14 so that the rechargeable battery 14 can electrically power those corresponding components.

The contacting portion 2 and the exposed portion 3 are preferably mounted to each other through a plurality of fasteners thus delineating two separate housing bodies. When the present invention is worn by the user, the contacting portion 2 rests upon the user neck and shoulder area while the exposed portion 3 is oriented towards the user's head. In reference to FIG. 1-4, the contacting portion 2 and the exposed portion 3 may each comprise a back section 4, a left shoulder section 6, and a right shoulder section 7. The left shoulder section 6 and the right shoulder section 7 are oppositely positioned of each other about a sagittal plane 5 of the back section 4 so that the housing 1 can be balanced around the user's neck. The left shoulder section 6 is terminally connected to the back section 4. The right shoulder section 7 is terminally connected to the back section 4. More specifically, when the present invention is worn around the user's neck, the back section 4 of the contacting portion 2 and the back section 4 of the exposed portion 3 are positioned behind the user's neck. The left shoulder section 6 of the contacting portion 2 sits upon the user's left shoulder, and the left shoulder section 6 of the exposed portion 3 is oriented toward the user's left ear. The right shoulder section 7 of the contacting portion 2 sits upon the user's right shoulder, and the right shoulder section 7 of the exposed portion 3 is oriented toward the user's right ear.

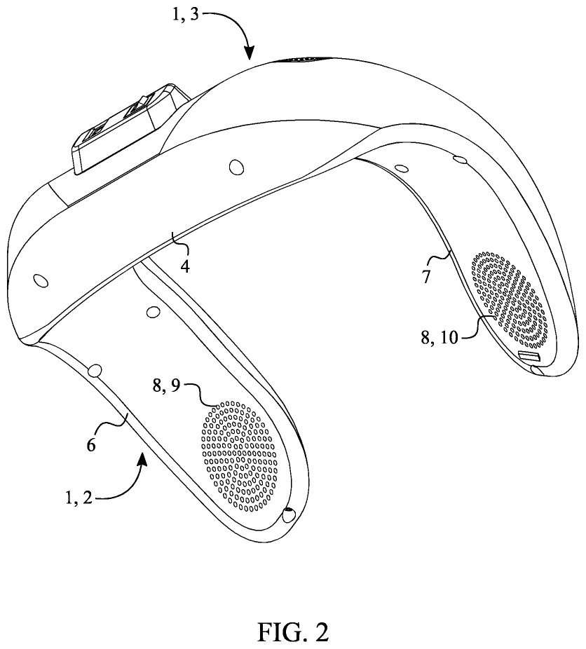

In reference to FIG. 2 and FIG. 4-5, the plurality of speakers 8 may comprise a first bass speaker 9 and a second bass speaker 10. The first bass speaker 9 and the second bass speaker 10 provide a rumbling effect on the user's body when the present invention is operational. More specifically, the first bass speaker 9 is internally mounted to the left shoulder section 6 of the contacting portion 2 and electrically connected to the rechargeable battery 14 through the amplifier 13. The second bass speaker 10 is internally mounted to the right shoulder section 7 of the contacting portion 2 and electrically connected to the rechargeable battery 14 through the amplifier 13. Due to the configuration of the first bass speaker 9 and the second bass speaker 10, the first bass speaker 9 provides the rumbling effect to the left side of the users body while the second bass speaker 10 provides the rumbling effect to the right side of the users body. Preferably, the first bass speaker 9 and the second bass speaker 10 operate within 16 hertz (Hz) to 250 Hz frequency range to accommodate low range sounds.

In reference to FIG. 1 and FIG. 3-5, the plurality of speakers 8 may further comprise a first set of surround sound speakers 11 and a second set of surround sound speakers 12 so that the surround sounds can be emitted towards the user's head. More specifically, the first set of surround sound speakers 11 is mounted onto the left shoulder section 6 of the exposed portion 3 and electrically connected to the rechargeable battery 14 through the amplifier 13. The second set of surround sound speakers 12 is mounted onto the right shoulder section 7 of the exposed portion 3 and electrically connected to the rechargeable battery 14 through the amplifier 13. Due to the configuration of the first set of surround sound speakers 11 and the second set of surround sound speakers 12, the first set of surround sound speakers 11 provides the surround sounds to the user's left ear while the second set of surround sound speakers 12 provides the surround sounds to the user's right ear. Preferably, the first set of surround sound speakers 11 and the second set of surround sound speakers 12 operate within 250 Hz to 20 kHz frequency range to accommodate midrange sounds and high range sounds.

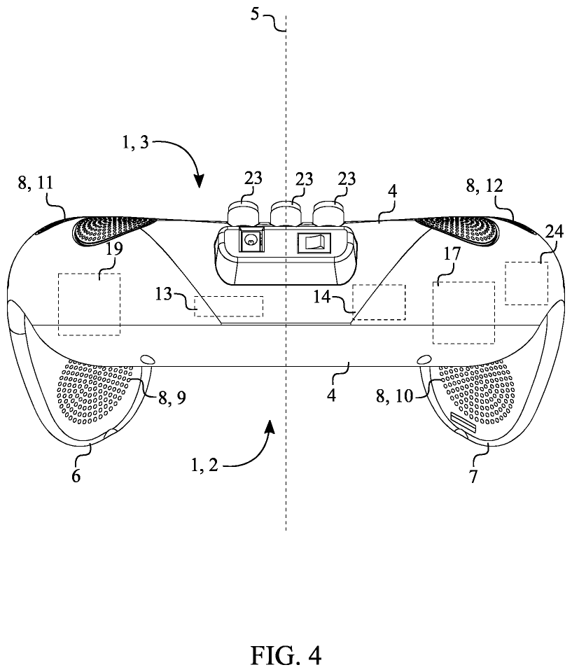

In reference to FIG. 4, the amplifier 13 is mounted adjacent to the back section 4 of the contacting portion 2 and the back section 4 of the exposed portion 3. The amplifier 13 uses the electric current from the rechargeable battery 14 to increase the amplitude of the sounds that inputted into the present invention from the gaming consoles or the gaming computers thus producing a proportionally grater amplitude signal to be emitted via the plurality of speakers 8. Preferably, the amplifier 13 is internally mounted within the exposed portion 3 so that the user can easily access the amplifier 13 through the removal of the contacting portion 2 for potential repairs.

In reference to FIG. 4, the rechargeable battery 14 is mounted adjacent to the back section 4 of the contacting portion 2 and the back section 4 of the exposed portion 3. The rechargeable battery 14 functions as the power source of the present invention and is preferably a lithium-ion battery to optimize the operation of the present invention. Preferably, the rechargeable battery 14 is internally mounted within the exposed portion 3 so that the user can easily access the rechargeable battery 14 through the removal of the contacting portion 2 for potential repairs or replacement.

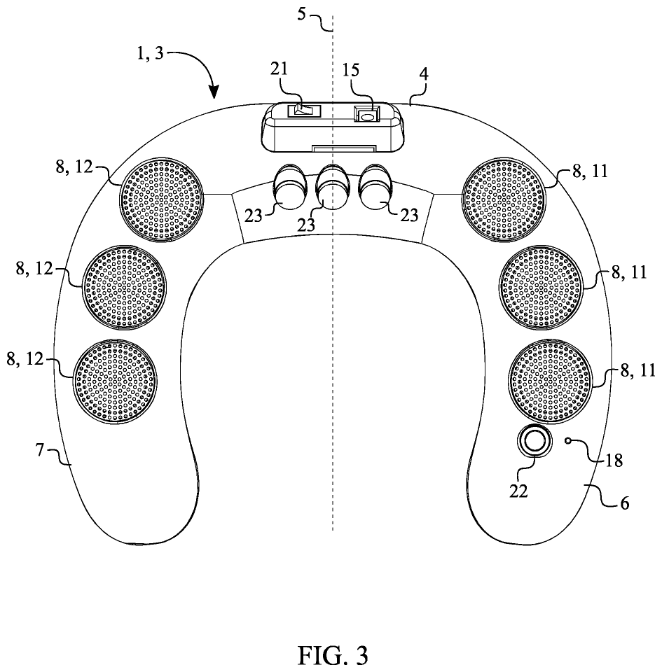

In reference to FIG. 3 and FIG. 5-6, the plurality of control buttons 20 may comprise a power button 21, a mute button 22, and at least one sound mode button 23 so that the user can operate the present invention. The amplifier 13 is electrically connected to the rechargeable battery 14 through the power button 21 thus allowing the power button 21 to turn-on or turn-off the present invention. The mute button 22 is electronically connected to the amplifier 13 so that the user is able to instantly mute the emitting sounds when necessary. The sound mode button 23 is electronically connected to the amplifier 13 thus enabling the user to adjust the entire frequency spectrum of the sounds. The sound mode button 23 can be a pre-programed button or manually adjusting button without deviating from the scope of the functionality. Preferably, the plurality of control buttons 20 is externally mounted to the exposed portion 3 so that the user can easily access them during the usage of the present invention.

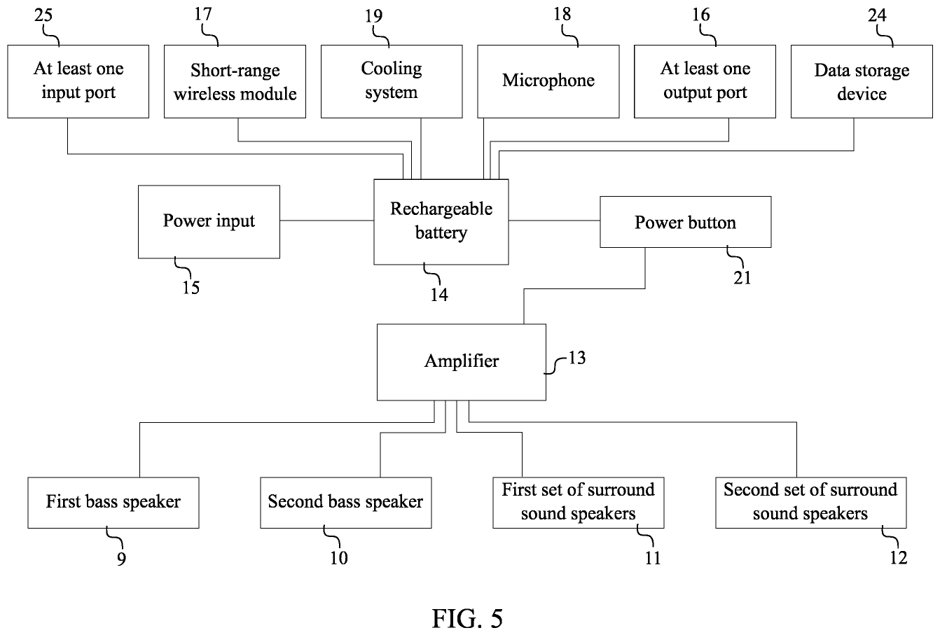

In reference to FIG. 4-5, the present invention may further comprise a power input 15 that is integrated onto the exposed portion 3 so that the user can plug in the external power source into the power input 15 during the usage of the present invention. The power input 15 is electrically connected to the rechargeable battery 14 so that an external power source, such as a battery charger, can recharge the rechargeable battery 14.

In reference to FIG. 1 and FIG. 5-6, the present invention may further comprise at least one output port 16. More specifically, the output port 16 is integrated onto the exposed portion 3 so that the user can easily plug in a headset or any other type of audio outputting devices. The output port 16 is electrically connected to the rechargeable battery 14 and electronically connected to the amplifier 13. The output port 16 can include, but is not limited to a 3.5 millimeter port, any type of Universal Serial Bus (USB), or any other type of audio output port.

In reference to FIG. 3 and FIG. 5, the present invention may further comprise a microphone 18 that is integrated onto the exposed portion 3. The microphone 18 being electronically connected to the amplifier 13 and electrically connected to the rechargeable battery 14. The microphone 18 converts sounds into an electrical signals to be processed via the amplifier 13.

In reference to FIG. 4-6, the present invention may further comprise a cooling system 19 that is mounted within the contacting portion 2 and the exposed portion 3. The cooling system 19 is electronically connected to the amplifier 13 and electrically connected to the rechargeable battery 14. As a result, the cooling system 19 is able to automatically turn-on and turn-off during the usage of the present invention to regulate and dissipate the generated heat within the housing 1.

In reference to FIG. 4-6, the present invention may further comprise a short-range wireless module 17 so that the present invention can wirelessly communicate with the gaming consoles or gaming computers. The short-range wireless module 17 is mounted within the contacting portion 2 and the exposed portion 3 to protect from outside elements. The short-range wireless module 17 is electronically connected to the amplifier 13 and electrically connected to the rechargeable battery 14.

In reference to FIG. 1 and FIG. 5-6, the present invention may further comprise at least one input port 25. More specifically, the input port 25 is integrated onto the exposed portion 3 so that the user can easily plug in the gaming consoles or gaming computers without having to use the short-range wireless module 17. The input port 25 is electrically connected to the rechargeable battery 14 and electronically connected to the amplifier 13. The input port 25 can include, but is not limited to, a 3.5-millimeter port, any type of USB, or any other type of audio input port.

In reference to FIG. 4-6, the present invention may further comprise a data storage device 24 so that the present invention can store audio files or video files. In other words, the data storage device 24 functions as a hard-drive and is mounted within the contacting portion 2 and the exposed portion 3 to protect from outside elements. The data storage device 24 is electronically connected to the amplifier 13 and electrically connected to the rechargeable battery 14. The data storage device 24 can be accessed through a data port that is integrated into the housing 1 so that an external computing device can store or delete data files.

Although the invention has been explained in relation to its preferred embodiment, it is to be understood that many other possible modifications and variations can be made without departing from the spirit and scope of the invention as hereinafter claimed.

What is claimed is:

1. A surround sound neckband comprising:
a housing;
a plurality of speakers;
an amplifier;
a rechargeable battery;
a plurality of control buttons;
the housing comprising a contacting portion and an exposed portion;
the contacting portion and the exposed portion perimetrically being mounted to each other;
the plurality of speakers being internally mounted to the housing;
the amplifier being mounted within the contacting portion and the exposed portion;
the rechargeable battery being mounted within the contacting portion and the exposed portion;
the plurality of control buttons being connected onto the housing; and
the plurality of speakers, the amplifier, and the plurality of control buttons being electrically connected to the rechargeable battery.

2. The surround sound neckband as claimed in claim 1 comprising:
the contacting portion and the exposed portion each comprising a back section, a left shoulder section, and a right shoulder section;
the left shoulder section and the right shoulder section being oppositely positioned of each other about a sagittal plane of the back section;
the left shoulder section being terminally connected to the back section; and
the right shoulder section being terminally connected to the back section.

3. The surround sound neckband as claimed in claim 1 comprising:
the plurality of speakers comprising a first bass speaker and a second bass speaker;
the first bass speaker being internally mounted to a left shoulder section of the contacting portion;
the second bass speaker being internally mounted to a right shoulder section of the contacting portion;
the first bass speaker being electrically connected to the rechargeable battery through the amplifier; and
the second bass speaker being electrically connected to the rechargeable battery through the amplifier.

4. The surround sound neckband as claimed in claim 1 comprising:
the plurality of speakers further comprising a first set of surround sound speakers and a second set of surround sound speakers;
the first set of surround sound speakers being mounted onto a left shoulder section of the exposed portion;
the second set of surround sound speakers being mounted onto a right shoulder section of the exposed portion;
the first set of surround sound speakers being electrically connected to the rechargeable battery through the amplifier; and
the second set of surround sound speakers being electrically connected to the rechargeable battery through the amplifier.

5. The surround sound neckband as claimed in claim 1, wherein the amplifier is mounted adjacent to a back section of the contacting portion and a back section of the exposed portion.

6. The surround sound neckband as claimed in claim 1, wherein the rechargeable battery is mounted adjacent to a back section of the contacting portion and a back section of the exposed portion.

7. The surround sound neckband as claimed in claim 1 comprising:
the plurality of control buttons comprising a power button, a mute button, and at least one sound mode button;
the amplifier being electrically connected to the rechargeable battery through the power button;
the mute button being electronically connected to the amplifier; and
the sound mode button being electronically connected to the amplifier.

8. The surround sound neckband as claimed in claim 1 comprising:
a power input;
the power input being integrated onto the exposed portion; and
the power input being electrically connected to the rechargeable battery.

9. The surround sound neckband as claimed in claim 1 comprising:
at least one output port;
the output port being integrated onto the exposed portion;
the output port being electronically connected to the amplifier; and
the output port being electrically connected to the rechargeable battery.

10. The surround sound neckband as claimed in claim 1 comprising:
a microphone;
the microphone being integrated onto the exposed portion;
the microphone being electronically connected to the amplifier; and
the microphone being electrically connected to the rechargeable battery.

11. The surround sound neckband as claimed in claim 1 comprising:
a cooling system;
the cooling system being mounted within the contacting portion and the exposed portion;
the cooling system being electronically connected to the amplifier; and
the cooling system being electrically connected to the rechargeable battery.

12. The surround sound neckband as claimed in claim 1 comprising:
a short-range wireless module;
the short-range wireless module being mounted within the contacting portion and the exposed portion;
the short-range wireless module being electronically connected to the amplifier; and
the short-range wireless module being electrically connected to the rechargeable battery.

13. The surround sound neckband as claimed in claim 1 comprising:
at least one input port;
the input port being integrated onto the exposed portion;
the input port being electronically connected to the amplifier; and
the input port being electrically connected to the rechargeable battery.

14. The surround sound neckband as claimed in claim 1 comprising:
a data storage device;
the data storage device being mounted within the contacting portion and the exposed portion;
the data storage device being electronically connected to the amplifier; and
the data storage device being electrically connected to the rechargeable battery.
